(19) United States
(12) Patent Application Publication
(10) Pub. No.: US 2006/0167895 A1
(43) Pub. Date: Jul. 27, 2006

(54) Database system and method for adapting a main database components in a main memory thereof

(76) Inventor: Sang Yup Shim, Seoul (KR)

Correspondence Address: CANTOR COLBURN, LLP, 55 GRIFFIN ROAD SOUTH, BLOOMFIELD, CT, 06002, US

(21) Appl. No.: 11/254,097

(22) Filed: Oct. 19, 2005

(30) Foreign Application Priority Data
Jan. 25, 2005 (KR) 10-2005-006532

(51) Int. Cl. G06F 7/00; G06F 17/30

(52) U.S. Cl. 707/10

(57) ABSTRACT

In a main memory database system constituted of the dual memory architecture of PRAM and DRAM as a main memory, a method for updating data in PRAM and DRAM includes Move-When-Write, memory allocation scheme in the dual memory architecture, and a method for dividing and storing database components in the PRAM and DRAM, comprises: determining properties of database components; determining which the components have higher importance required for maintaining the consistency and integrity in a database according to the determined properties of database components; if importance of some of the database components is determined to high level, transmitting the determined high components to PRAM; storing the transmitted database components in PRAM; if importance of some of the database components is determined to low level, transmitting the determined low components to DRAM; and storing lower importance of database components to DRAM, and capturing as snapshot the stored database components by periods, thereby providing very high-speed response time and high transaction throughput by including a Persistent RAM as a main memory and 64-bit processor.

### BACKGROUND OF THE INVENTION

1. Field of the Invention

The present invention generally relates to computer data storage systems. More particularly, the invention relates to systems and methods for increasing the performance of computer data systems by adapting a main memory database into dual main memory architecture.

2. Description of the Related Art

Usually, database systems have become a central and critical element of business infrastructure with the development and widespread use of computer systems and electronic data. Businesses typically rely on computer databases to be the safe harbor for storage and retrieval of very large amounts of vital information. The speed and storage capacities of computer systems have grown exponentially over the years, as has the need for larger and faster database systems.

In recent years, there has been a tremendous need to process a huge amount of data with lesser amount of time. For instance, OLTP (Online Transaction Processing) applications such as online trading require faster access to system to process the transactions and to provide quicker update information to the users. OLAP (Online Analytical Processing) applications use data mining to process massive ODS (Operational Data Store) to make data models.

These applications need to process huge and complex data within a very short response time. Conventional database system that has applied the applications comprises a MMDB (Main memory databases) known as memory resident databases and a DRDA (Disk resident databases).

The memory resident databases stores data in a main memory, and the Disk resident databases stores data in files on physical disk. The operations of the conventional database system are explained to reference to FIG. 1 and FIG. 2.

FIG. 1 is a block diagram illustrating one example of a computer system architecture in which embodiments of the conventional MMDB 100 operate.

The database system 100 includes a client computer system 110, a volatile storage database system 114, and a persistent storage device 113, as shown in FIG. 1. The client computer system 110 is used by clients or users of the database system 100 to access the volatile storage database system 114. The client computer system 110 transmits database commands, for example, read and write commands to the volatile storage database system 114.

A CPU 111 included in the volatile storage database system 114 can store data on the persistent storage device such as a disk, and simultaneously store data for high-speed retrieval on a main memory of the volatile storage database system. As such, the conventional main memory resident databases had not made significant impact on the computer industry database in spite of tremendous advantage of speed, storage space, and accessibility.

FIG. 2 is a block diagram illustrating the other example of computer system architecture 200 in which embodiments of the conventional disk resident database system operate.

The computer system architecture 200 includes a client computer system 210, a database server 230, and a database system 250, as shown in FIG. 2. The client computer system 210 is used by clients or users of a database system 250 to access the database system 250. The data is stored on the database, i.e. disk.

The database server 230 receives database commands, i.e. read and write commands transmitted by the client computer system 210 via a network 210. The database server 230 also determines whether to send the database commands to the database system 250.

The database commands can be initiated through user input on the client computer system 210, or generated by an application running on the database server 230.

The database server 230 receives the read command transmitted by the client computer system 210 and transmits it to the database system 250. After that, the database information of the database system 250 is backup to a buffer 240 as a cache memory and then transmitted the information to one or more client computer system 210.

As described above, in the conventional disk resistant database system, the update time that the client computer system 210 is accessed to the database system 250 takes a long time, because data to be updated are resided on the disk, thereby lowering data throughput.

Thus, the database systems need to have their faster response time and more transaction throughput compared to conventional disk resident database systems with the same degree of data consistency.

### SUMMARY OF THE INVENTION

The present invention has been developed in order to solve the above drawback and other problems associated with the conventional database systems. An object of the present invention is to organize the dual memory architecture where the memory is consisted of a persistent main memory system and a dynamic main memory. This is different from the conventional memory architecture that one type of memory exists in a system. This dual memory architecture is needed for providing very high-speed response time and high transaction throughput with data persistency by including a Persistent RAM as the part of the main memory. With the wide availability of 64-bit processors, it is possible to add more than 4 GBytes of memory in a system.

According to one embodiment of the present invention, the database system comprises: a client computer system for transmitting database read/write commands in response to a user operation, a main memory (DRAM) for storing continuously data and meta data, and automatically storing all data updates(writes) into a persistent main memory including the meta data utilizing copy-when-write (CWW) memory allocation scheme; a processor connected to the main memory for receiving a database command from a client computer system and sending a corresponding command to either the dynamic main memory or the persistent main memory, and receiving a database read command requesting data and reading the requested data from the main memory.

Preferably, the persistent main memory is the memory that provides non-volatile storage as the similar speed characteristics of DRAM.

A database system according to another embodiment of the invention comprises: a client computer system for transmitting database read/write commands in response to user operation, a main memory constituted of a volatile memory and a nonvolatile memory for distributing and storing user tables, user indexes, catalog tables, histogram tables, constraints, lock files and transaction logs according to properties each of memory; and a processor connected to the main memory for receiving a database write command and sending a corresponding write commands to the main memory, and receiving a database read command requesting the data and reading the requested data from the main memory.

Preferably, the database system according to the invention further comprises a disk storage device for storing only backup copy of file data and meta data.

In the dual memory system constituted of PRAM and DRAM as a main memory, a method for dividing and storing database components in the PRAM and DRAM, comprises: determining properties of database components, for example database consistency, size, static/dynamic nature, ease of re-creation; determining which components have higher importance required for maintaining the consistency and integrity in a database according to the determined properties of database components; if importance of some of the database components is determined to high level, transmitting the determined high components to PRAM; storing the transmitted database components in PRAM; if importance of some of the database components is determined to low level, transmitting the determined low components to DRAM; storing lower importance of database components to DRAM, and capturing as snapshot the stored database components by periods.

Preferably, the database system further comprises a client computer system for communicating with the processor, and sending the database read commands and the database write commands in response to user operation.

Preferably, the processor comprises 64-bit processor but not required.

A method for allocating move-when-write pages to DRAM and PRAM in a database system, comprises: executing an update instruction of the page by a processor; determining an address of the update pages to be stored to DRAM; copying all the pages to PRAM; reallocating the existing pages in DRAM; updating the page table bit to indicate the pages to PRAM; performing the update instruction in the pages in PRAM.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating one example of a computer system architecture in which embodiments of the conventional MMDB operate.

FIG. 2 is a block diagram illustrating the other example of computer system architecture in which embodiments of the conventional disk resident database system operate.

FIG. 3 is a block diagram illustrating an example of database system equipped with Persistent Random Access Memory (PRAM) as a main memory according to one embodiment of the invention.

FIG. 4 shows a main memory in a database system comprised of PRAM and DRAM according to one embodiment of the invention.

FIG. 5 is flowchart illustrating process for dividing and storing one or more database components to DRAM and PRAM.

FIG. 6 shows a Move-When-Write page allocation policy according to the one embodiment of the invention.

FIG. 7 is flowchart illustrating Move-When-Write operation according to the Move-When-Write page allocation policy according to the one embodiment of the invention.

FIG. 8 is flowchart illustrating process for updating pages including data section of the program.

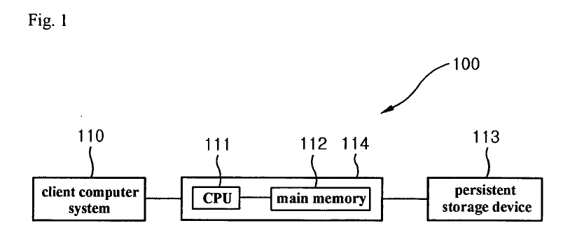

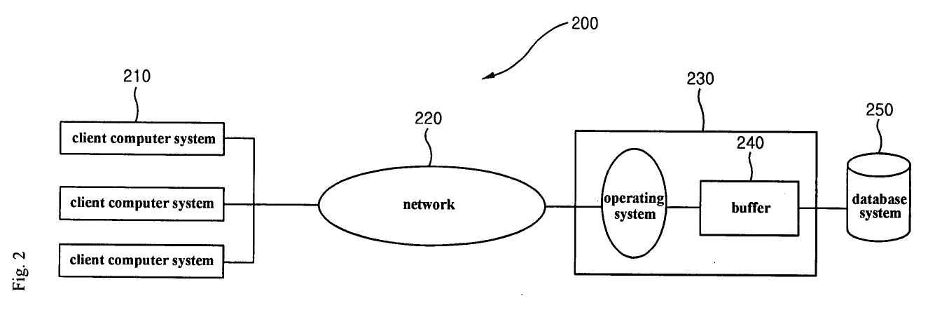

### DETAILED DESCRIPTION OF THE PREFERRED EMBODIMENTS

Hereafter, Certain embodiments of the present invention will be described in greater detail with reference to the accompanying drawings.

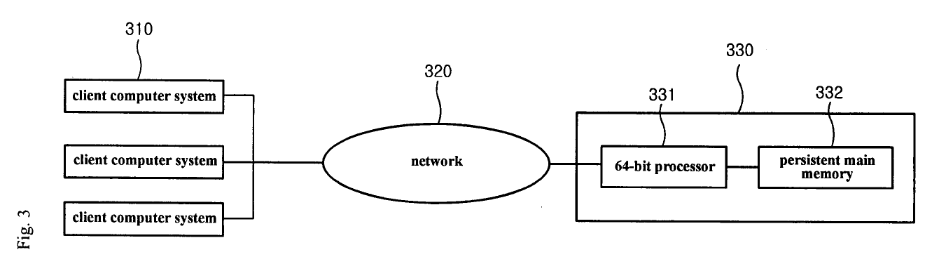

FIG. 3 is a block diagram illustrating an example of database system equipped with Persistent Random Access Memory (PRAM) as a main memory according to one embodiment of the invention.

Referring to FIG. 3, the database system 300 includes a client computer system 310 and a database server 330.

The client computer system 310 may be one or more computer and associated input devices. The users can input the database commands and view database information via a graphical user interface (GUI) that executes on the client computer system 310. The client computer system 310 can also employ other types of user interface, such as scripting language files or command line interfaces.

The database server 330 can be implemented in computer or a computer system that can process data in high-speed with 64-bit processor 331 and PRAM 332 as a main memory. The database server 330 receives database commands, for example, read and write commands transmitted by the client computer system 310 via a network 320.

The client computer system 310 can be indirectly connected to the database server 330 via the network 320. Alternatively, the database server 330 can be also connected directly with the client computer system 310.

The database server 330 stores all data or files in a non-volatile PRAM 332 equipped with itself. As a result, the database server 330 can operate in higher speed than conventional databases, because the 64-bit processor directly accesses the PRAM 332 to process the data or files. Also, the database server 330 according to the invention can accomplish safety identical with the disk in spite of data processing of the high-speed. In addition, the database system may also include disks that are only used to capture backup copy, rather than main storage for file data and meta-data. The files are used only to maintain consistency and sincerity in the database.

As described above, memory access speed of PRAM 332 compared to the disk can access in higher speed. In other words, while memory access speed of PRAM 332 is nanoseconds, memory access speed of disk is milliseconds. In other words, a response time of PRAM compared to the disk is several thousands of speed. Thus, PRAM is become to main storage area of the main memory database.

Furthermore, PRAM 332 stores one or more database components, for example, catalog table, user tables, user index, histogram tables, compiled statements, constraints, stored procedures, lock files, transaction logs, DDL scripts.

Hereafter, the database components will be explained.

First, transaction logs are provided in a persistent main memory database (PMMDB) 300 to maintain the integrity of the data in the database. The existence of transaction logs is significant in a main memory database (MMDB) and a disk resistant database (DRDB) as main memory is volatile. It is also important in PMMDB to record all transactions in case of auditing but not necessarily for recovery, if all data and meta data are stored in PRAM.

Transaction logs record transactions, provide checkpoints, and help in recovery in case of system crashes or power failures. The log buffer is stored in PRAM. Two types of transaction logs in main memory database system include Committed/Roll-backed Transaction Logs (CRTL) and Active Transaction Logs (ATL).

CRTL stores all the transactions that are committed or roll backed since the last backup to the PRAM is taken. After the backup of CRTL log is taken to PRAM, the logs in a CRTL log file are purged. The structure of CRTL is shown below.

| Element name | Description |
|---|---|
| Transaction Id | Unique sequential transaction Id |
| System Id | Transaction initiator system (future use) |
| SQL Status | C/R (Committed or Roll backed) |
| SQL Code | SQL Code for transaction |
| System Error (Optional) | System error if any (future use) |
| SQL Operations | Array of SQL operations |

The SQL operation structures are shown below.

| Time in Julian times stamp | Time when transaction is logged |
|---|---|
| Operation type | S/I/D/U (Select/Insert/Delete/Update) |
| Object Name | Object name of table or index |
| SQL Statement | SQL statement in the transaction |

The active transaction log maintains the entries for active transactions in the database. It also maintains the pointers of locks in a lock log for each active transaction. Once the transaction is completed (committed or roll backed), entry of the transaction is written in the committed/rollback transaction log (CRTL) and gets purged from active transaction log (ATL).

Lock log contains the set of locks currently held on the database objects. Each lock record in lock log maintains the information such as lock Id, transaction Id (which initiates the lock), the type of lock (read/write), element name on which the lock is being created, granularity of the lock (record/table), key in case of record lock (null in case of table lock). After every committed or roll-backed transaction, entries in the lock tables are deleted for that transaction.

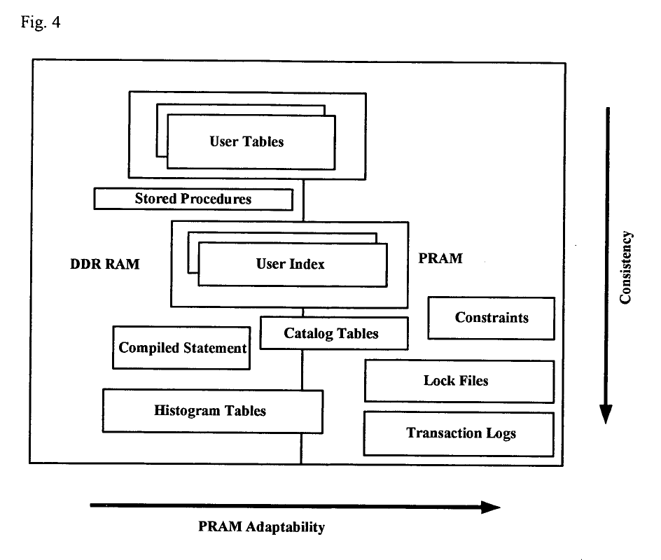

FIG. 4 shows a main memory in a database system comprised of PRAM and DRAM according to one embodiment of the invention.

Referring to FIG. 4, this figure shows the distribution of database components in the PMMDB model. In PMMDB data model, all of the database components can be stored in the PRAM. However, if there is not enough PRAM to store all the components, some of the components can be stored in the DRAM.

Usually, the components that are smaller in size but have higher importance in terms of availability can be stored in PRAM. For example, transaction log that has higher importance in maintaining integrity and consistency in the database may be stored in the PRAM, because if the transaction log stored in conventional memory is lost due to power outage or system reboot, the in-process transactional data may be lost and can not be recovered.

The decision of which components need to be stored in the PRAM depends on criteria such as importance of database component in maintaining database consistency, size of the component, ease of creation/recreation, its inflation in terms of size, static nature of the component, and availability of PRAM in a system. For example, DDL scripts for tables and indexes creation have smaller size, can be easily created, and are static in nature (do not change frequently). Hence, DDL scripts are not good candidates to store in the PRAM.

The following table shows the results for deciding the properties of one or more database components.

| | Database | | Nature | Ease of | |
|---|---|---|---|---|---|
| Component | Consistency | Size | (static/dynamic) | Recreation | Inflation |
| Catalog table | High | Small | Static | Easy | Small |
| User tables | Moderate | Very | Highly dynamic | Moderate | Very high |
| | | high | | | |
| User index | Moderate | Moderate | Highly dynamic | Moderate | High |
| Histogram | Low | Small | Dynamic | Easy | Small |
| Tables | | | | | |
| Compiled | Low | Small | Static | Easy | Small |
| Statements | | | | | |
| Constraints | High | Small | Static | Moderate | Small |
| Stored | Low | Moderate | Static | Easy | Small |
| Procedure | | | | | |
| Lock files | High | Moderate | Highly dynamic | Not easy | Moderate |
| Transaction | High | Moderate | Highly | Not easy | Moderate |
| logs | | | | | |
| DDL Scripts | Low | Small | Static | Easy | Small |

As shown in above the table, the PMMDB components properties are measured in term of their adaptability for PRAM and their importance to be stored in PRAM for database integrity and consistency.

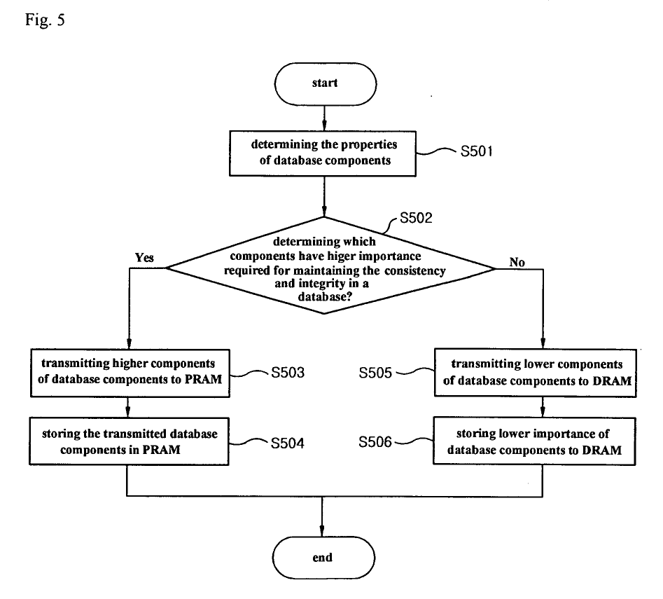

FIG. 5 is flowchart illustrating process for dividing and storing one or more database components to DRAM and PRAM.

In database system comprised of PRAM and DRAM as a main memory, a method for dividing and storing database components in the PRAM and DRAM comprises a step for: (a) determining the properties of database components, for example database consistency, size, static/dynamic nature, ease of re-creation (step 1), (b) determining which components have higher importance required for maintaining the consistency and integrity in a database according to the determined properties of database components (step 2), (c) transmitting higher components of database components to PRAM (step 3), (d) storing the transmitted database components in PRAM, if importance of some of the database components is higher (step 4), (e) transmitting lower components of database components to DRAM, if importance of some of the database components is lower (step 5), and (f) storing lower importance of database components to DRAM, and capturing as snapshot the stored database components by periods (step 6).

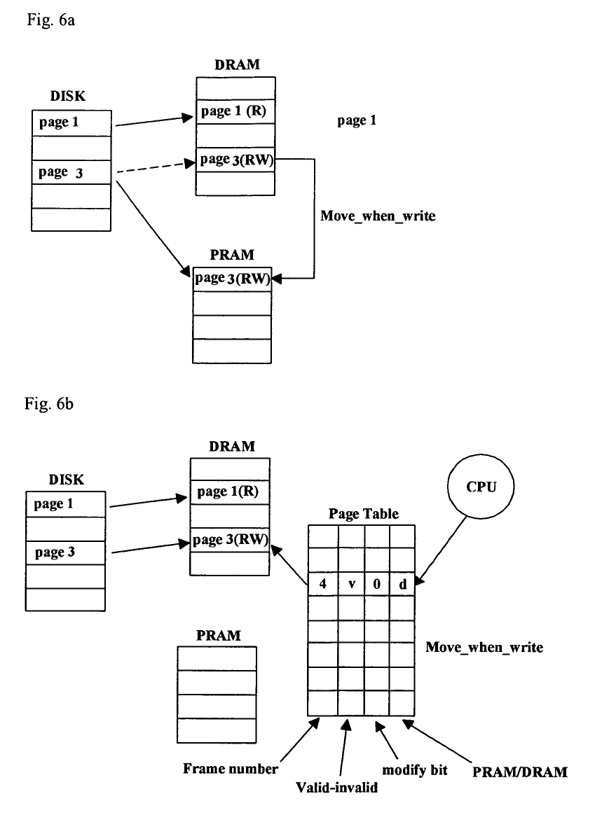

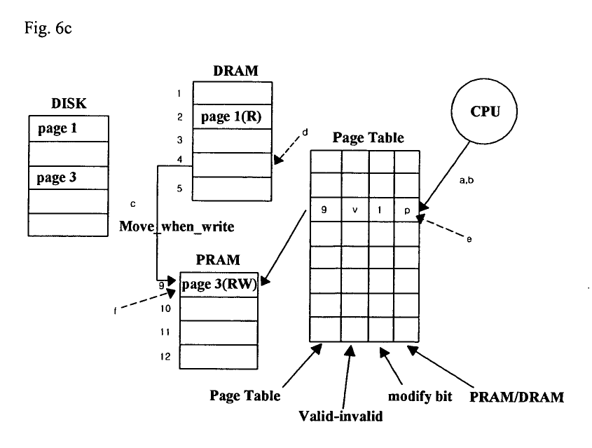

FIG. 6 shows a Move-When-Write page allocation policy according to the one embodiment of the invention.

Referring to FIG. 6, PRAM 332 embodied in the database system according to the invention provides persistence even when the power is off. Thus, when a process is started, pages brought into DRAM. When the pages are writable, the pages are marked as move-when-write pages. This means that if a process writes to these pages, these pages are automatically moved to PRAM to provide persistence.

For example, assume that a process attempts to modify a page containing data section of the program. If the pages are set to be move-when-write, then the operating system will copy the page from DRAM to PRAM. Hence, the pages become persistent automatically. When move-on-write pages are used, the pages that are modified by the process are moved to PRAM and all unmodified pages are stayed in DRAM.

Note that the only writable pages are marked as move-when-write. Since the modified pages are kept in PRAM, the identification of the logical and physical mapping has to be stored in PRAM so that during the system failure recovery, the contents of move-on-write pages can be recovered from PRAM. Hence, this allocation policy provides easy recovery utilizing persistency of PRAM.

This policy can be applied broadly to an operating system, and database system when PRAM is used.

FIG. 6a shows flowchart illustrating Move-When-Write operation according to the Move-When-Write page allocation policy. FIG. 6b shows the status of the page structure before the write operation. FIG. 6c shows the status of the page structure after the write operation.

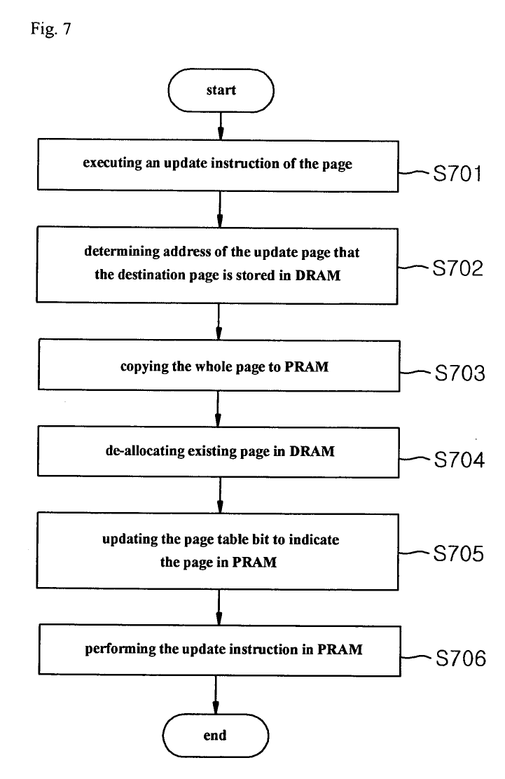

Referring to FIG. 7, in a method for allocating move-when-write pages to DRAM and PRAM in a database system, first, an update instruction of the page by a processor is executed by CPU (step 701)

Next, an address of the update pages is determined that the destination page is stored in DRAM (step 702).

Next, the whole page is copied to PRAM (step 703).

Next, the existing page in DRAM is re-allocated (step 704).

Next, the page table bit is updated to indicate the pages to PRAM (step 705).

The update instruction is performed in the page in PRAM (step 706).

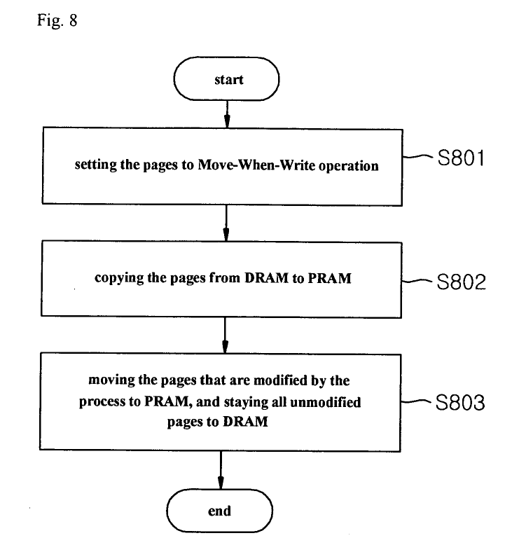

FIG. 8 is flowchart illustrating a method for updating pages including data section of the program.

Referring to FIG. 8, the pages are set to be move-when-write operation (step 801).

The operation system copies the pages from DRAM to PRAM, and becomes persistent automatically (step 802).

When move-on write pages are used, the pages that are modified by the process are moved to PRAM, and all unmodified pages are stayed in DRAM (step 803).

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. a database system comprises:
a client computer system for transmitting database read/write commands in response to an user operation;
a main memory for storing continuously tables of file data and meta data; and
a processor connected to the persistent main memory for receiving a database write command from the client computer system and sending a corresponding write command to the persistent main memory, and receiving a database read command that requests some of the data and reading the requested data from the persistent main memory.

2. The database system as claimed in claim 1, wherein the processor comprises 64-bit processor.

3. The database system as claimed in claim 1, further comprising a disk storage device for storing only backup copy of file data and meta data.

4. The database system as claimed in claim 1, wherein the main memory comprises PRAM.

5. A database system comprises: a client computer system for transmitting database read/write commands in response to user operation;
a main memory consisted of a volatile memory and a non-volatile for dividing and storing user tables, user indexes, catalog tables, histogram tables, constraints, lock files and transaction logs according to properties each of memory; and
a processor connected directly to the main memory for receiving a database write command and sending a corresponding write commands to the main memory, and receiving a database read command that requests some of the data and reading the requested data from the main memory

6. The database system as claimed in claim 5, wherein the properties of the database components comprises consistency, static/dynamic nature, easy of re-creation, size of the database.

7. The database system as claimed in claim 5, wherein the volatile memory is DRAM, and the non-volatile memory is PRAM.

8. The database system as claimed in claim 7, wherein the PRAM stores database components that properties of the components have smaller size, higher consistency of data, and dynamic nature, the stored components comprising catalog tables, constraints, lock files and transaction logs.

9. The database system as claimed in claim 7, wherein the DRAM stores database components that properties of the components have easy of re-creation and static nature, the stored components comprising user tables, user indexes, and histogram tables.

10. The database system as claimed in claim 5, further comprising a disk storage device for storing only backup copy of file data and meta data.

11. In a main memory database system constituted of PRAM and DRAM as a main memory, a method for dividing and storing database components in the PRAM and DRAM, comprises: determining properties of database components;
determining which the components have higher importance required for maintaining the consistency and integrity in a database according to the determined properties of database components;
if importance of some of the database components is determined to high level, transmitting the determined high components to PRAM;
storing the transmitted database components in PRAM;
if importance of some of the database components is determined to low level, transmitting the determined low components to DRAM; and
storing lower importance of database components to DRAM, and capturing as snapshot the stored database components by periods.

12. The method as claimed in claim 11, the properties of the database components comprises consistency, static/dynamic nature, easy of re-creation, and size of the database.

13. The method as claimed in claim 11, wherein the PRAM stores database components that properties of the components have smaller size, higher consistency of data, and dynamic nature, the stored components comprising catalog tables, constraints, lock files and transaction logs.

14. A method for allocating move-when-write pages to DRAM and PRAM in a database system, comprises: executing an update instruction of the pages by a processor;
determining an address of the update pages to be stored to DRAM;
copying all the pages to PRAM;
reallocating the existing pages in DRAM;
updating the page table bit to indicate the pages to PRAM; and
performing the update instruction in the pages in PRAM.

15. A method for updating pages including data section of the program, comprises:
setting the pages by move-when-write operation;
copying the pages from DRAM to PRAM by an operating system; and
When move-on write pages are used, the pages that are modified by the process are moved to PRAM, and all unmodified pages are stayed in DRAM.
